(19) United States
(12) Patent Application Publication
(10) Pub. No.: US 2008/0275706 A1
(43) Pub. Date: Nov. 6, 2008

(54) Greeting card that is colored or decorated and has a recording and playback device built into the card

(76) Inventor: Joseph W. Paulini, Vienna, VA (US)

Correspondence Address: JOSEPH W. PAULINI, 8203 WESTWOOD MEWS COURT, VIENNA, VA, 22182, US

(21) Appl. No.: 11/797,230

(22) Filed: May 2, 2007

(51) Int. Cl. G10L 11/00

(52) U.S. Cl. 704/272; 704/E11.001

(57) ABSTRACT

A greeting card that is designed to be colored or decorated by a user with various types of decorating and coloring media and implements, that has a thin, compact built-in record/playback device and components that play a personalized audio message recorded by the sender. The sender colors or decorates the artwork preprinted on the greeting card. The card can also hold a photograph, art print or drawing as the sender so may choose. The card contains a circuit board that has an IC chip with memory to store an audio message. The sender depresses and holds a switch inside the card to record sound into the audio storage device. When the card is opened the playback device is activated by a play switch mounted inside the card and the message is played. The message can be recorded over until the user is satisfied with the recording. When the card is in a closed position the message cannot be erased if the record button is accidentally depressed.

### REFERENCE TO PRIOR APPLICATION

60/793,612

### REFERENCES CITED

U.S. patent Documents:

| | |
|---|---|
| Sasaki et al | 5652606 |
| Kaiser | 5370421 |
| Reddock | D341850 |
| Johnson et al | 5063698 |
| Pines | 2003/0156686 |
| Lee | 6845583 |
| Soscia | 6441921 |
| Dawson | 5761836 |
| Chomette et al | 6028752 |
| Barnett et al | 3462157 |
| Holland | 6588129 |
| Lemelson et al | 6816679 |
| Hogue et al | 6104306 |
| Crowell | 5577918 |
| Galloway et al | 4611262 |
| Jacobson et al | 5903869 |

### BACKGROUND OF THE INVENTION

1. Field of the Invention

This invention relates to greeting cards, particularly to a card that can be personalized with a users' own particular artwork and can have an audio message recorded directly into the greeting card.

2. Description of the Related Art

A greeting card is sent to an individual for special events or holidays to express a feeling, sentiment or emotion to the recipient. The card is typically printed on paper, cardstock or flexible plastics with pictures or illustrations related to the holiday or the special event to support or emphasize the personal message written within the card. The message may be a brief note showing appreciations, congratulations and affections. The delivered card represents an emotional connection and sentiment intended to be conveyed to the recipient.

Over 7 billion greeting cards are produced in the United States each year attesting to the huge popularity of sending and receiving cards. Greeting cards take various forms to provide special meaning and effect. Cards can contain three dimensional, die or laser cut pop-up art, confetti, glitters, and others small items making the card personal and interesting to the recipient.

The technology for incorporating music or various other sounds within a greeting card is well known and very popular. Examples are found of cards with prerecorded popular music, unusual noises and record-your-own message cards.

Individuals seek cards that are unique, unusual and what is thought to be pleasing to the tastes of the intended receiver of the card. Although there are many technologies and techniques available that allow individuals to develop a card unique to their tastes, not all persons are able or interested in starting from scratch to make a card. Although there are readily available technologies and techniques that enable individuals to create personalized greeting cards, the number of people who are able or willing to customize a card is limited. Collecting software programs or supplies to create a card can be time consuming and expensive. Also as noted above, in limited distribution are greeting cards that can record a personal voice or sound message included by the card giver.

Therefore, what is new and needed is a combination greeting card that can easily be personalized with coloring and decorating items and have the capability to record a customized audio message.

### BRIEF SUMMARY OF THE INVENTION

The present invention is a new and improved way to personalize a greeting card that has not existed before.

The greeting card is designed to be colored and or decorated and to allow for a card sender to personalize a recordable audio message of voice or any sound the sender desires. The card is unique in that the user can color or decorate the outline-type artwork printed on the card and then record a voice or any sound generated by the user of the card.

The card can come packaged with various coloring and decorating tools (including but not limited to crayons, watercolor or acrylic paints and the necessary brushes, colored pencils, colored markers, inks or other coloring media, ribbons, dried plant material, stickers, glues and sprinkle-on glitters and colors).

With very little effort a card entirely unique to the card sender can be easily created. The preprinted artwork provides an outline for the user to color or decorate and a simple to use recording device is packaged in the card. The card package makes it easy for anyone who wishes to create a unique and customized greeting card.

Much of the artwork is rendered in outline form. The artwork is either black-line outlined artwork with areas clear of color, or lightly outlined artwork for the users to use paints, markers or other coloring and decorating media as previously noted. Some designs can have areas previously colored or flocked to enhance the design. The user will color or decorate as they choose, or in certain cases by using coloring and decorating recommendations included in the package. In some designs the front panel can resemble a picture frame that can be colored and an area to insert a photograph or illustration.

The recording device is designed in such a way as to allow the user to record sound that can be overwritten repeatedly until the user is satisfied with the recording.

The playback device can be activated by simply opening the greeting card.

The greeting card can be mailed through the postal service without the message being accidentally erased.

The compact design of the record/playback device allows for varying sizes of greeting cards.

### BRIEF DESCRIPTION OF THE DRAWINGS

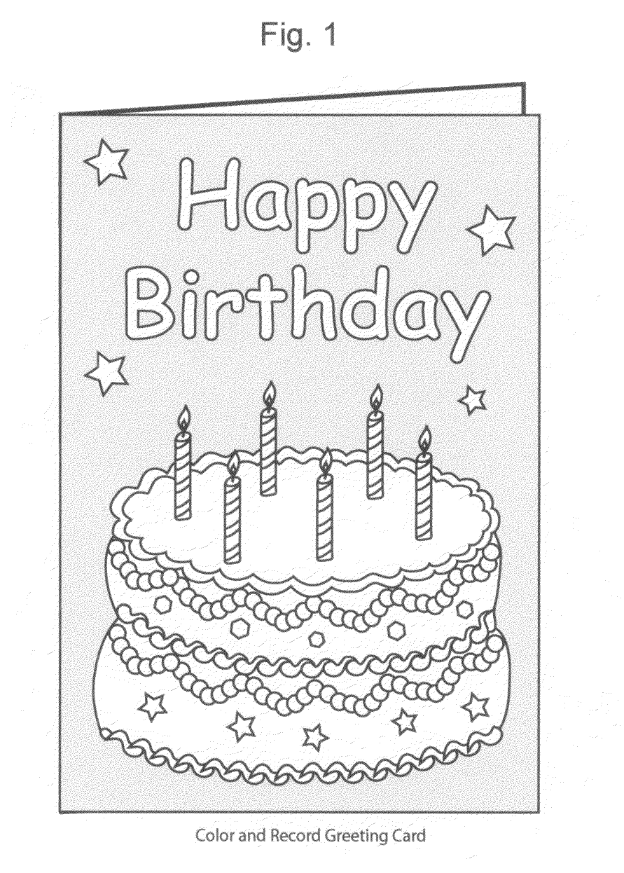

The invention is a greeting card that in its folded position is relatively flat and fits into an ordinary mailing envelope or package (FIG. 1).

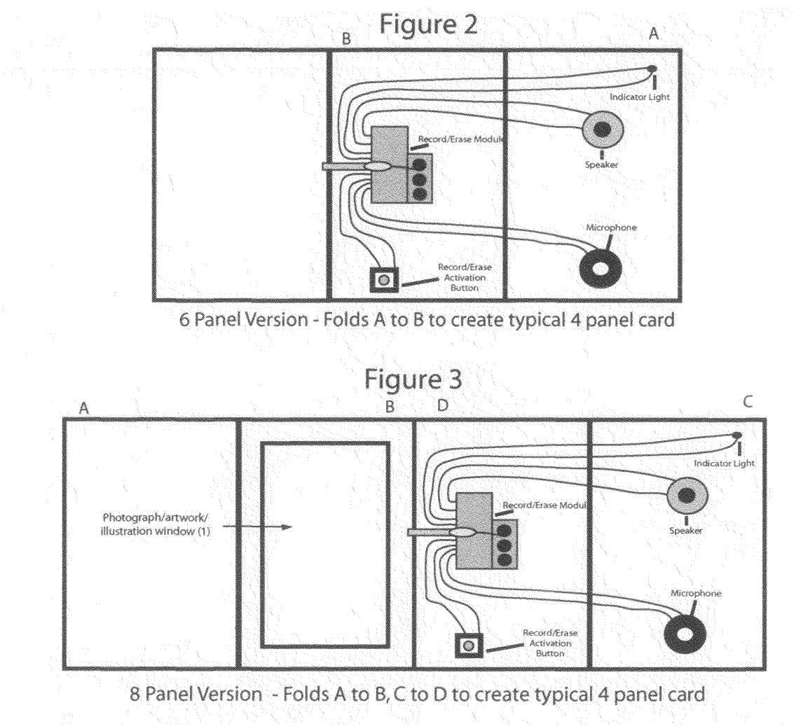

The card has multiple panels prior to folding into its finished state. In a six panel version (FIG. 2), four of the panels fold together to conceal electronics.

In an eight panel version (FIG. 3) four panels fold together to create a place to insert a photograph or illustration and the other four fold over to conceal and contain the electronics.

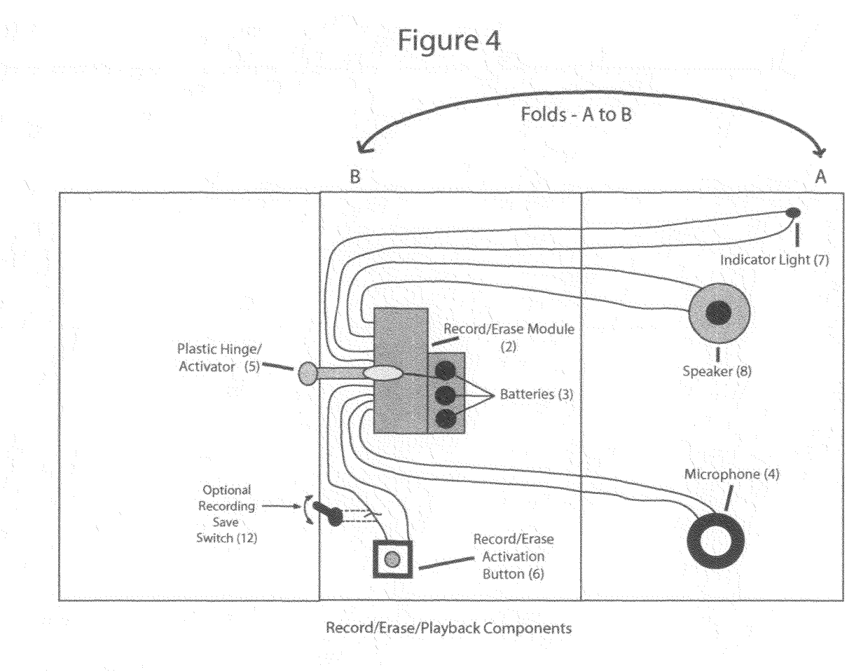

The card has mounted within four panels folded together an electronic recording/playback module along with the batteries, a microphone, a switch to activate the recording/erasing process, an on/off record/erase device, a recording/playback indicator light, a speaker, and in some designs flashing LED's (light emitting diodes). (FIG. 4)

Printed on the card, is artwork rendered in outline form, (FIG. 1).

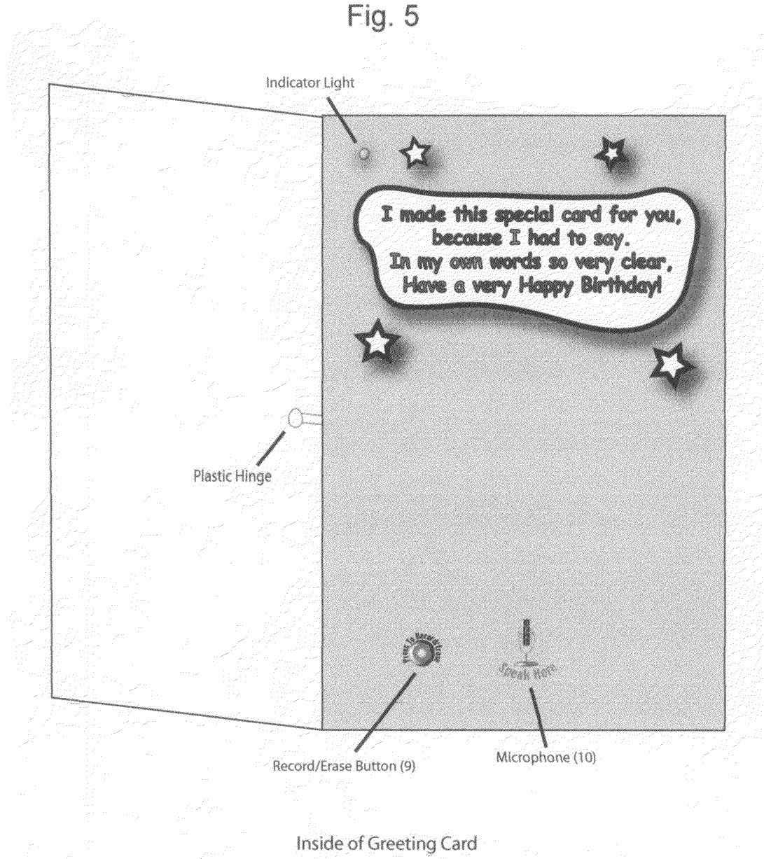

When the folded card is opened there is verse and artwork within (FIG. 5). In some designs the front panel can resemble a picture frame that can be colored and an area to insert a photograph, artwork or an illustration.

The user will record a personalized message or other sounds into the card. By opening the card a plastic hinge will open the electronic circuit in preparation for recording (FIG. 5). Once the final message is recorded it will replay each time the card is reopened.

On certain models of the card there will be a switching device installed (29) that when moved into proper position prevents recording over the saved message. Conversely, when the switching device is moved back into the original position, it allows the users to record over or erase the recorded message.

### DETAILED DESCRIPTION OF THE INVENTION

The invention is a foldable greeting card that in its folded position is relatively flat, resembles a traditional flat-folded greeting card and fits into an ordinary mailing envelope (FIG. 1) or mailing package.

The card, which should be understood as also meaning a greeting card, and the envelope can be made of stiff or flexible paper, card stock or various plastics. Depending on the individual model, the card can have multiple panels. For example, the card is shown in six (FIG. 2) or eight panel (FIG. 3) configurations prior to folding into its finished state (FIG. 1). In a six panel (FIG. 2) or eight panel version (FIG. 2), four of the panels fold together to conceal the electronics that record and playback sound. Regardless of the number of panels used the card will have four panels that fold together to conceal the electronics.

In an eight panel version (FIG. 3) four panels fold together to create a place resembling a picture frame (1) to insert a photograph, artwork or illustration and the other four fold over to conceal and contain the electronics. In its folded state, both versions of the card will appear to have four panels as typically seen in traditional greeting cards.

The card has mounted within four panels folded together (FIG. 4) an electronic recording and playback module (2) along with the batteries (3), a microphone (4), a switch to activate the recording/erasing process (5), an on/off record/erase device (6), a recording/playback indicator light (7), a speaker (8), and in some designs flashing LED's (light emitting diodes). (FIG. 4)

Printed on the card, is artwork rendered in outline form, (FIG. 1). The artwork on the card is either black-line outlined artwork with areas clear of color, or lightly outlined artwork for the users to use paints, markers or other coloring and decorating media as previously noted. Some designs can have areas colored or flocked during production to enhance the design. The purchaser/end user will color or decorate in the clear areas as they choose or in certain cases by using coloring or decorating recommendations included in the package. In some designs the front panel will resemble a picture frame that can be colored or decorated and has an area to insert a photograph, artwork or illustration.

When the folded card is opened there can be verse and artwork within (FIG. 5). There is also printed icons indicating the position of the Record/Erase Button (9) and the Microphone (10)

The user will record a personalized message or other sounds into the card. By opening the card a plastic hinge (5) (FIG. 4) will open the electronic circuit in preparation for recording. Then by pressing the Record/Erase Button icon printed within the card, an indicator light (7) will illuminate, which indicates the beginning of the recording process. While pressing and holding the switch the user speaks or directs other sound into the concealed microphone (4) and records a personalized message for the length of time that the indicator LED (7) is illuminated. When the time is up the indicator light will turn off. The time of recording is governed by the type of sound chip installed in the card. The user closes the card and when the card is opened again the hinge (5) triggers the playback module to replay the message through the speaker (8). By repeating the recording procedures the user can re-record the message repeatedly until satisfied with the message. Once the final message is recorded it will replay each time the card is opened.

On certain models of the card there will be a switching device installed (12) that when moved into proper position prevents recording over the saved message. Conversely, when the switching device is moved back into the original position, it allows the user to record over or erase the recorded message.

The card, coloring and decorating media and envelope are packaged so that all materials remain together through the retail sale of the product.

As it is evident that those skilled in creative and technical arts may find many alternative means, modifications and variations on the foregoing description of the present invention, the claims are meant to cover modifications and changes within the spirit and scope of the present invention.

1. (canceled)

2. A method of creating a greeting card package, which can be individually personalized by including the following steps:
producing a greeting card with an audio recording and/or playback system embedded within the greeting card;
providing artwork on the greeting card; and
providing decorating instruments for customizing the artwork on the greeting card.

3. Apparatus including:
A greeting card;
An audio recording and/or playback device embedded in the card; and
a package of decorating instruments for customizing the artwork.
